(19) United States
(12) Patent Application Publication
(10) Pub. No.: US 2023/0099925 A1
(43) Pub. Date: Mar. 30, 2023

(54) SYSTEMS, METHODS, AND DEVICES FOR ENVIRONMENT DETECTION FOR THE VISION IMPAIRED

(71) Applicant: Andiee's, LLC dba Hexagon IT Solutions, Lehi, UT (US)

(72) Inventors: Janarthanan Dakshnamoorthy, Lehi, UT (US); Siva Subramaniam, Lehi, UT (US)

(73) Assignee: Andiee's, LLC dba Hexagon IT Solutions, Lehi, UT (US)

(21) Appl. No.: 17/948,577

(22) Filed: Sep. 20, 2022

Related U.S. Application Data
(60) Provisional application No. 63/246,058, filed on Sep. 20, 2021.

(51) Int. Cl. A61H 3/06

(52) U.S. Cl. CPC A61H 3/061; A61H 3/068; A61H 2003/065; A61H 2201/5048; A61H 2201/5092

(57) ABSTRACT

Systems, devices, and methods are provided which provide a processor in a server computer, a device including an optical sensor, and a cane. The device may be connected electronically to a cane through wired or wireless technology. The cane may include a haptic controller which provides a notification to a user.

### PRIORITY CLAIM

This application claims priority to and benefit under 35 U.S.C. 119 to U.S. Provisional Pat. Application No. 63/246,058 filed on Sep. 20, 2021 which is incorporated herein by reference in its entirety, including but not limited to those portions that specifically appear hereinafter, the incorporation by reference being made with the following exception: In the event that any portion of the above-referenced applications are inconsistent with this application, this application supersedes said portion of said above-referenced applications.

### TECHNICAL FIELD

The disclosure relates generally to systems, methods, and devices that incorporate an optical sensor to both detect and identify objects or people in an environment around a user. Typically, the users are vision impaired and rely at least partially on sensory input other than sight to navigate their environment. The systems, methods, and devices disclosed herein are directed toward providing sensory input to a vision impaired user to help vision impaired users navigate their environment.

### BACKGROUND

Visual impairments have long been a problem for humans, especially in severe cases where vision impairment is total such that a person is totally blind. Even in cases where a person does not suffer from total blindness, blurred vision can also cause significant stress or injury to a person who cannot adequately assess the environment around them. Historically, visual impairment was so vexing that it was considered a miracle for a person’s sight to be restored. Many historical texts refer to miracles that were performed in restoring sight to the blind as a manifestation of divine providence. Mankind, has also relied on technological attempts to improve the sight of people experiencing visual affliction.

In ancient history those who suffered visual impairment were typically led around by placing their hand on the shoulder or arm of a friend or relative or a stick held in front of a user to detect objects in the user’s path. It was not until the Greco-Roman era that the first evidence of visual aid devices were developed and those were merely corrective devices for those whose affliction was biologically suitable to be corrected. For example, the human eye includes a lens which allows light to pass to light receptors in the back of the eye. This light is transmitted by nerves, essentially, to the brain for interpretation and provides sight. Very simply put, afflictions that affect the ability of the eye to focus light on the light receptors in the eye have traditionally been correctable, or at least improvable, through technological supplement. Afflictions that cause disruption between in the nerves between the light receptors in the eye and the brain have not been historically correctable. There are a host of afflictions that cause blindness and this is not intended to be a complete list of those afflictions. Rather, this is a simplified explanation of at least one problem that results in correctable vision problems and currently un-correctable vision problems.

The earliest vision correction or improvement articles came about with the development of a convex lens. Convex lenses could be used to focus light for the eye, magnify visual images, and offset imperfections in the shape of a person’s eye that caused visual impairment. Convex lenses came about in at least a practical sense approximately a thousand years ago and were implemented in glasses, telescopes, magnifying lenses, monocles, and other similar developments to enhance visual acuity for those that are afflicted with light focusing problems in the eye or, those with naturally normal eyesight to see more than what is visible through natural eyesight. Glasses became the most popular form of visual acuity improvement technology and have been improved in more recent times by the invention of bifocals, trifocals, lenses that address astigmatism, polarization, and a host of other ailments.

However, for those that suffer from afflictions that have disruption in the nerves between the eye and the brain or other similar problem, cannot be helped by glasses or other currently available technological developments for correcting the lens shape and light focusing ability of the eye, simply because the eye is not the source of the blindness in these individuals. Thus, many of the people with these afflictions are limited to being escorted by a friend or relative to interpret the world around them or use a cane, traditionally a white cane, to detect objects in front of them by moving the cane left and right, and sometimes up and down, in their path to detect objects before the person walks into objects in their path. Many of these individuals can move around their homes based on knowing relative distances between objects, such as a table and a couch. However, in more unfamiliar areas, it may be difficult for these people to move confidently, without fear they will trip or hurt themselves walking into objects they are not aware of.

It is therefore one object of this disclosure to provide a system which provides an optical sensor which gives audible feedback to a user for the detection and identification of obstacles in their path. It is another object of this disclosure to provide a device which includes tactile feedback that provides informational messages to a user via a braille printer. It is another object of this disclosure to provide a device which includes tactile feedback in the form of vibration to the user once an object is detected. It is a further object of this disclosure to provide the system and the devices to operate in tandem for providing a user with tactile feedback and audible feedback for detecting and identifying obstacles or people in their path. It is a further object of this disclosure for providing a method for identifying and detecting obstacles or people in a user’s path using the system and devices disclosed herein.

### SUMMARY

Disclosed herein is a system, device, and method for detecting and identifying objects in the path of a visually impaired person using an optical sensor.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings:

FIG. 1 illustrates block diagram of a system for environment detection, identification, and notification.

FIG. 2 illustrates an optical sensor device for environment detection, identification, and notification.

FIG. 3A illustrates a cane device using a braille printer and a vibration unit for environment detection, identification, and notification.

FIG. 3B illustrates a collapsible cane device using a braille printer and a vibration unit for environment detection, identification, and notification.

FIG. 4 illustrates a necktie for an alternative optical sensor device.

FIG. 5 illustrates elements of a system for detecting known objects in an environment.

FIG. 6 illustrates elements of a system for analyzing terrain in an environment.

FIG. 7 illustrates elements of a system for detecting objects based on objects and terrain information.

FIG. 8 illustrates elements of a system for creating a model of terrain in an environment.

FIG. 9 illustrates elements of a system for generating a posture/gait information.

FIG. 10 illustrates elements of a system for estimating personal space around a user.

FIG. 11 illustrates a system for analyzing an environment around a user.

FIG. 12 illustrates a system for providing notifications about the environment to a user.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

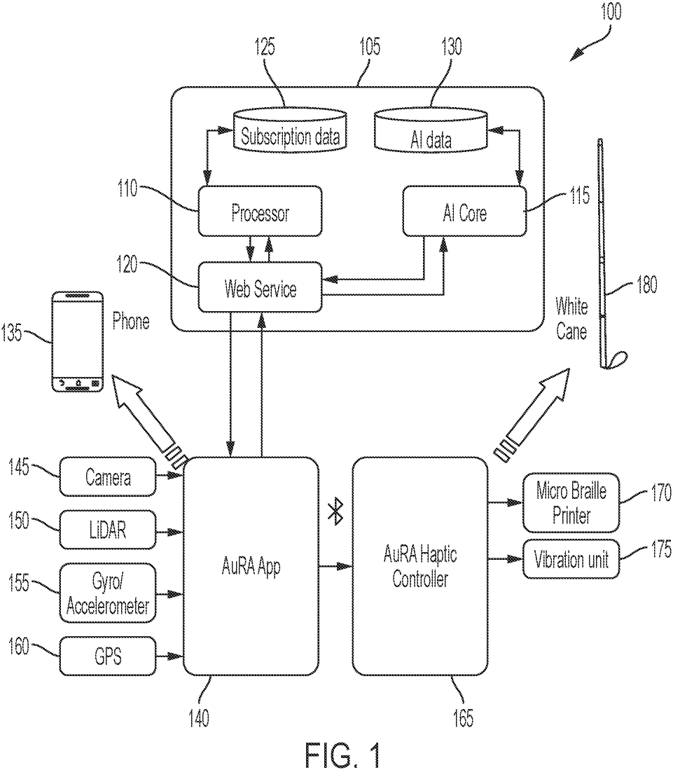

FIG. 1 illustrates block diagram of a system 100 for environment detection, identification, and notification. System 100 may be accessible to an administrator or a user through access to a server computer 105, or via an application 140 on a personal device 135, such as a smart phone or similar electronic device. Server computer 105 may include a processor 110 which interfaces with an artificial intelligence core 115 either directly or via a web service 120. Processor 110 may be implemented as a hardware components implementing modules and may be implemented with or as part of a other devices which may include a combination of processors, microcontrollers, busses, volatile and non-volatile memory devices, non-transitory computer readable memory device and media, data processors, control devices, transmitters, receivers, antennas, transceivers, input devices, output devices, network interface devices, and other types of components that are apparent to those skilled in the art. Server computer 105 may further include subscription data in a memory storage 125 which may identify contractual agreements between users and service providers to provide environment detection for the users. Server computer 130 may further incorporate artificial intelligence data in a memory storage 130 which may be used by artificial intelligence core 130 for object identification and detection, as will be described below.

Server computer 105 may connect to an application 140 executed by personal device 135. Personal device 135 may be implemented as a smart phone, a tablet, a laptop computer, a desktop computer, a music storage and playback device, a personal digital assistant, or any other device incorporating a processor which is capable of implementing a software application that may interact with, control, and provide information to server computer 105 or haptic controller 165, as will be discussed below. Personal device 135 may incorporate one or more of a camera 145, an optical sensor 150 (which may be incorporated as LIDAR technology in one example), a gyro or accelerometer 155, and a global positioning sensor 160, each of which may be controlled by application 140. LIDAR refers to “light detection and ranging” or “laser imaging, detection, and ranging” technology.

Personal device 135 may include hardware that connects personal device 135 to the Internet for the purpose of sharing information between a server device, such as server computer 105, and a haptic controller 165 using any appropriate communication protocol. For example, connections between personal device 135 and server computer 105 or haptic controller 165 may be implemented using Wi-Fi, ZigBee, Z-Wave, RF4CE, Ethernet, telephone line, cellular channels, or others that operate in accordance with protocols defined in IEEE (Institute of Electrical and Electronics Engineers) 802.11, 801.11a, 801.11b, 801.11e, 802.11 g, 802.11h, 802.11i, 802.11n, 802.16, 802.16d, 802.16e, or 802.16 m using any network type including a wide-area network (“WAN”), a local-area network (“LAN”), a 2G network, a 3G network, a 4G network, a 5G network, a Worldwide Interoperability for Microwave Access (WiMAX) network, a Long Term Evolution (LTE) network, Code-Division Multiple Access (CDMA) network, Wideband CDMA (WCDMA) network, any type of satellite or cellular network, or any other appropriate protocol to facilitate communication. Haptic controller 165 may be implemented within a cane 180 and may operate a micro-braille printer 170 and a vibration unit 175.

System 100, which will be discussed in significant detail below, may for brief purposes of introduction use an optical sensor, such as a camera 145, and or optical sensor 150 that uses LIDAR technology to view an environment around a user of system 100. This information may be transmitted to server computer 105 and interpreted by artificial intelligence core 115 to identify and detect objects in the users environment. Images detected through camera 145 or optical sensor 150 individually or collectively may be provided to server computer 105 for processing by artificial intelligence core 115 and processor 110. Artificial intelligence core 115 may be trained for detecting objects in images, or images assembled together as a video stream provided by camera 145 or optical sensor 150. Object detection may occur as a result of comparing objects in the images or video stream to training data stored in AI data 130. Artificial intelligence core 115 may further identify faces of known individuals. The detected location of the objects may be communicated to the user by an audible warning from personal device 135. For example, if a car is exiting a grocery store parking lot, optical sensor 150, for example, may detect that a car is within a predetermined or undetermined distance from a user walking on a sidewalk that crosses the exit to the grocery store parking lot. Application 140 executed by a processor in personal device 135 may cause an audible warning to be emitted of the nature of “A vehicle has entered your path 25 feet ahead of you.” Personal device 135 may further transmit warning information to haptic controller 165 and cause vibration unit 175 in cane 180 to vibrate as a warning and/or may cause micro braille printer 170 to print a warning, in braille, that informs the user that a vehicle has entered the user’s path. While this is a simple explanation of system 100 for introductory purposes, system 100 may incorporate a host of other abilities as will be described below using the various devices and methods herein.

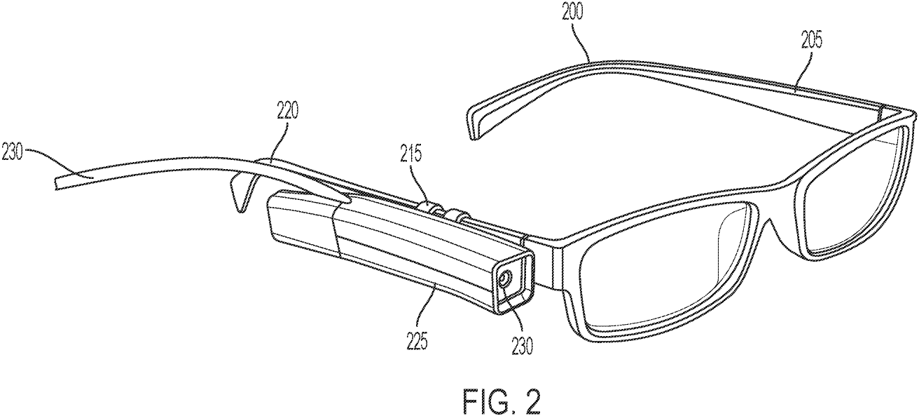

FIG. 2 illustrates an optical sensor device 200 for environment detection, identification, and notification. As shown in FIG. 2, optical sensor device 200 may be implemented as eye glasses that include a frame 205 having a bracket 215 which connects to one or more temples 220 of frame 200 and to an optical sensor 225 which incorporates an optical sensor emitter/detector 230. Bracket 215 may be implemented as a plastic clip, as an adhesive, or any other means of connection for optical sensor 225 to optical sensor device 200. Optical sensor 225 may connect to a personal device, such as personal device 135 shown and explained above with respect to FIG. 1, by a wire 230 which provides both power to optical sensor 225 and information exchange with optical sensor 225.

As shown in FIG. 2, optical sensor device 200 includes only a single optical sensor 225. It is conceivable that optical sensor device 200 may incorporate two optical sensors 225 on opposing sides of optical sensor device 200. For example, frame 205 may be fitted on each of the temples 220 of the frame with an optical sensor 225 and corresponding optical emitter/detectors 230 and wires 235. Optical sensor device 200 may be used with or in place of, for example, camera 145 and optical sensor 150 to provide visual data to personal electronic device 135. In one embodiment, optical sensor device 200 may implement LIDAR based emitter/detectors 230 for detecting objects in an environment around the user.

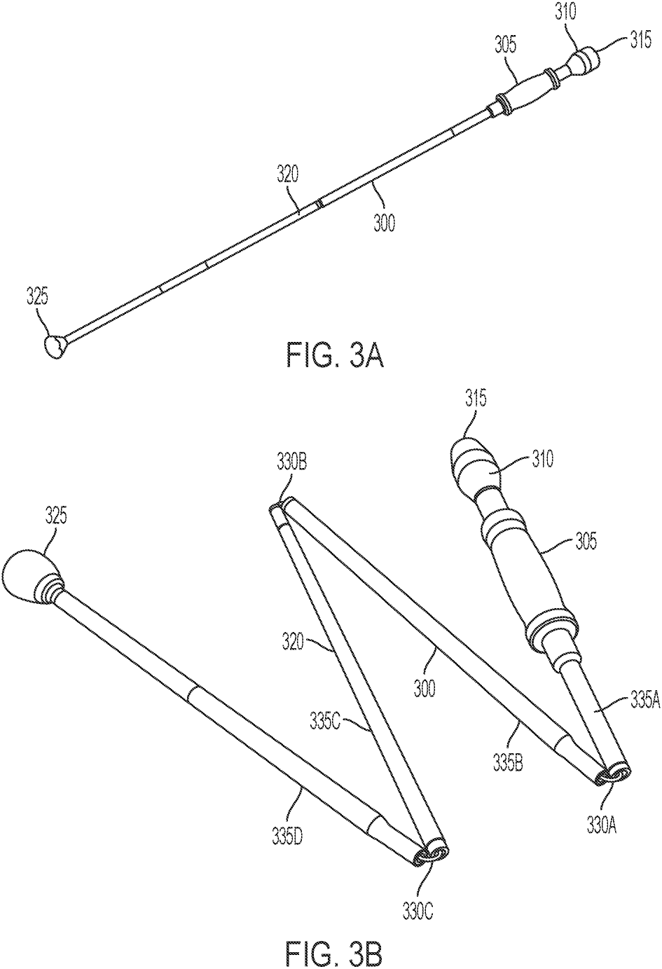

FIG. 3A illustrates a cane 300 device using a braille printer 315 and a vibration unit 310 for environment detection, identification, and notification. Cane 300 may be implemented as a solid or hollow tube 320 made of a plastic, fiberglass, graphite, carbon fiber, metals, or any other suitable material which includes a tip 325, which is also preferably rubber or a plastic knob at the end of cane 300. Cane 300 may be fitted with one or more electronics 305 which include a battery, a processor, memory, information storage devices, and other circuitry which interface with vibration unit 310 and a braille printer 315. Cane 300 may interface with a personal electronic device using wired or wireless communication protocols discussed herein and provide tactile feedback to a user about the environment around the user. For example, vibration unit 310 may vibrate to warn of an uneven sidewalk in the user’s path detected by personal electronic device 135 or optical sensor device 200, for example. Vibration unit 310 may be used as a warning without specifying what the warning is if the warning is provided audibly using the techniques described above. However, a braille message may be provided by braille printer 315 that includes information about the warning and the location of the detected object in the user’s path. Braille printer 315 may be implemented as a matrix of six holes with pins that protrude or are recessed, selectively by, in one embodiment, a servo mechanism, that raises and lowers pins, to spell words in a tactile fashion using the braille alphabet. Braille printer 315 may provide one matrix of six holes with pins to spell a single letter at a time or multiple matrices of six holes to spell a plurality of letters at the same time. In this way, both blind and deaf users can receive and interpret information about the environment around them.

FIG. 3B illustrates a collapsible cane device 300 using a braille printer 315 and a vibration unit 310 for environment detection, identification, and notification. Collapsible cane device 300 is shown in FIG. 3B implemented as a collapsible cane instead of a solid cane as shown in FIG. 3A. Thus, while collapsible cane includes electronics 305, vibration unit 310, braille printer 315, and tip 325, as shown in FIG. 3A, shaft 320 is divided into multiple parts 335A, 335B, 335C, 335D which are respectively separated by joints 330A, 330B, and 330C. Collapsible cane device 300 may further include stretchable cordage which allows multiple parts 335A-335D to separate but also tends to pull multiple parts 335A-335D back together when multiple parts 335A-335D are not held together by hand or a case or another retainer.

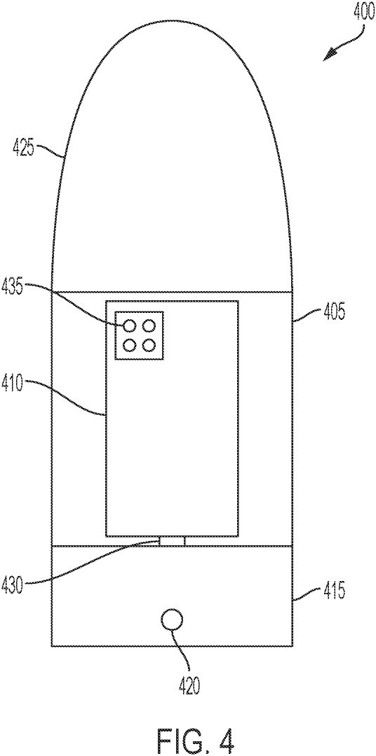

FIG. 4 illustrates a necktie 400 for an alternative optical sensor device 410. Necktie may include a support 405 which accepts a personal electronic device, such as personal electronic device 135, shown in FIG. 1, which acts as an optical sensor device 410 in FIG. 4. Necktie 400 may further include a battery 415 which may supplement a battery in optical sensor device 410 and include a power on/off switch 420. Necktie may further provide a connector 430 which acts as a direct connection between necktie and optical sensor device 410. Necktie 400 may further include a looped connection which is sized to easily slide over the head of a user such that necktie 400 rests on the neck of the user. Necktie 400 may therefore be carried on the chest of the user to provide optical sensor device 410 a view of the environment around the user. Optical sensor device 410 may include a plurality of emitter/detectors 435 which may include a LIDAR emitter detector, a camera, a light, and other types of emitter/detectors.

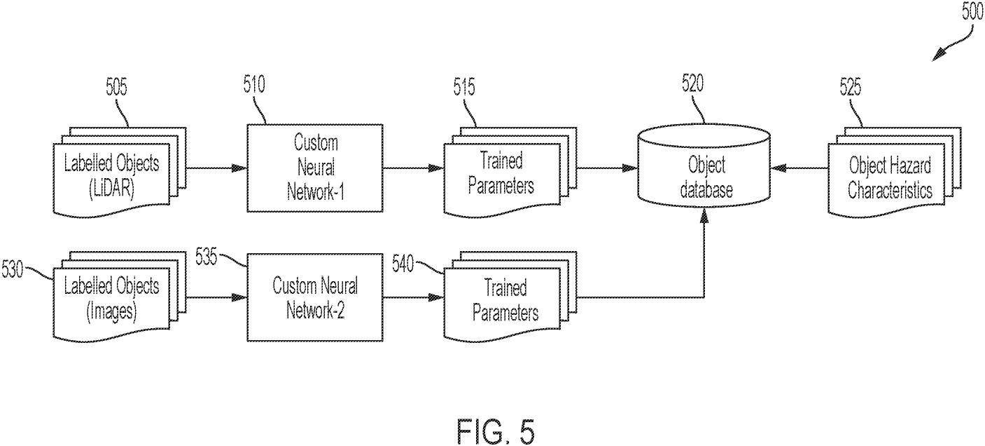

FIG. 5 illustrates elements of a system 500 for detecting known objects in an environment. System 500 may be implemented as part of system 100, shown in FIG. 1. For example, server computer 105 may implement processor 110 to create object database 520, as described below. Server computer 105 may receive information as either objects identified by an optical sensor, such as optical sensor 150 or by a camera 145. Objects obtained through the optical sensor may be referred to as “LIDAR objects” 505 while objects obtained through camera 145 may be referred to as “image objects” 530. LIDAR objects 505 may be provided to artificial intelligence core 115 and as a custom neural network 510 for deriving information from LIDAR objects 505. Custom neural network 510 may identify one or more parameters 515 which are provided to an object database 520 for storage of information about the object. Similarly, image objects may be provided to artificial intelligence core 115 and a custom neural network 525 which identifies one or more parameters 540 to an object database.

These parameters for either LIDAR objects or for image objects may include hazard characteristics of an object, such as injury potential, fragility, typical weight, density, dimension in terms of statistical means and variance, and even texture characteristics. The relative degree of hazard for these objects may be identified manually or by artificial intelligence core 115 as object hazard characteristics 525. Thus, the object library may be used to identify similar objects when encountered in the future and identify the most urgent or most dangerous object to the user in the user’s path.

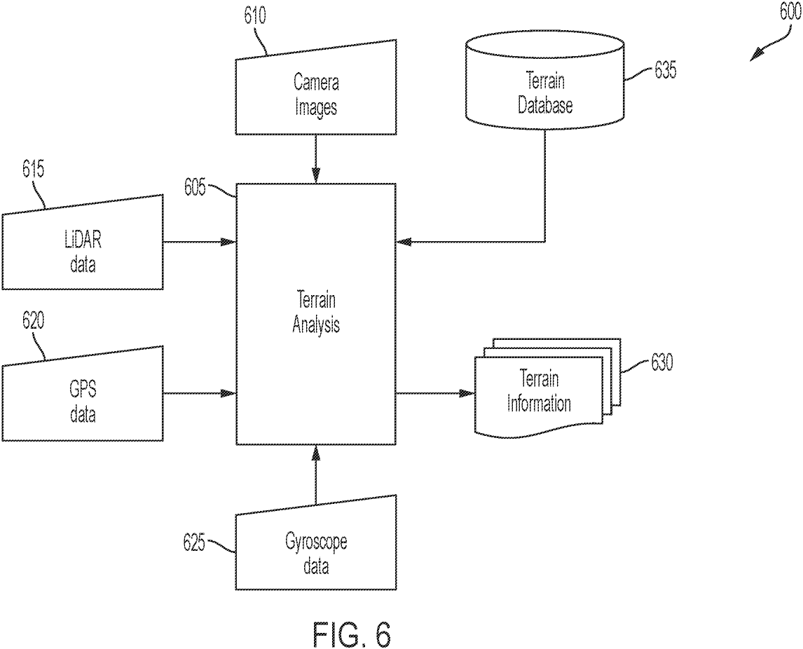

FIG. 6 illustrates elements of a system 600 for analyzing terrain in an environment. System 600 may be implemented as part of system 100, shown in FIG. 1. A terrain analyzer 605 may collect data 615 from an optical sensor, such as optical sensor 150, which may be, but need not be limited to, LIDAR data. Terrain analyzer 605 may further collect images 610 from camera 145 for analysis. Based on either one or both of the data 615 from the optical sensor 150, and images 610, terrain analyzer 605 may generate landscape details for a particular area identified by global positioning system receiver 160 and corresponding GPS data 620 to identify elevation, slopes, and water bodies. Gyroscope data 625 from gyro/accelerometer 155 may provide calibration data for terrain analyzer to map a particular terrain, provided the same terrain has not already been mapped and stored in terrain database 635. Terrain analyzer 605 may provide terrain information 630 to the user via personal device 135. Terrain analyzer 605 may be activated whenever optical sensor 150 including camera 145 whenever optical sensor 150 or camera 145 are turned on. Terrain analyzer 605 may iteratively compare terrain information detected through optical sensor 150 or camera 145 to ensure that real-world location coordinates (e.g., GPS coordinates) and system 100 coordinates are synchronized. Terrain analyzer 605 may further cause a system 600 and or system 100 to perform a re-synchronization whenever a gait or posture change is detected, whenever personal device 135 approaches a private space, or at specific time durations (e.g., every hour, or every two hours) to correct for sensor drift.

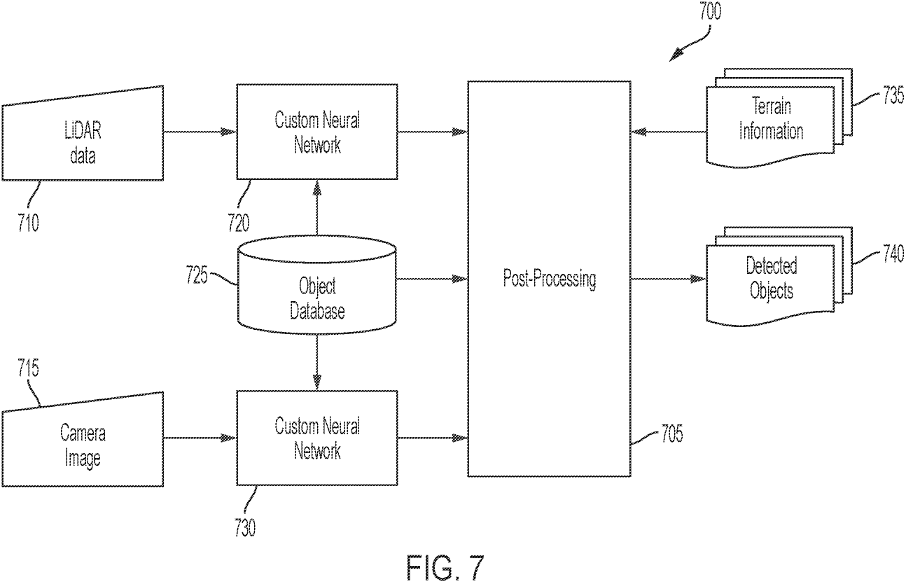

FIG. 7 illustrates elements of a system 700 for detecting objects based on objects and terrain information. System 700 may be implemented as part of system 100, shown in FIG. 1. System 700 may analyze data 710 collected from optical sensor 155 and images 715 collected from camera 145 with respective neural network 720 and neural network 730 to detect objects in an environment of the user. Information from neural network 720 and neural network 730 may be informed by information from object database 725 which may be similar to object database 520, discussed above with respect to FIG. 5 in a processor 705 for post processing.

Processor 705 may use data created via custom neural network 720, object database 725, neural network 730, and terrain information 735, which is similar to terrain information 630, shown in FIG. 6, to detect an object 740. Neural networks 720 and 730 may be trained as part of creating an object database 520 to detect specific objects that may be within a user’s path. Processor 705 may rely on terrain information to generate a list of objects and their characteristics that have been detected. In this manner, the relative danger of each of these objects may also be assessed by processor 705.

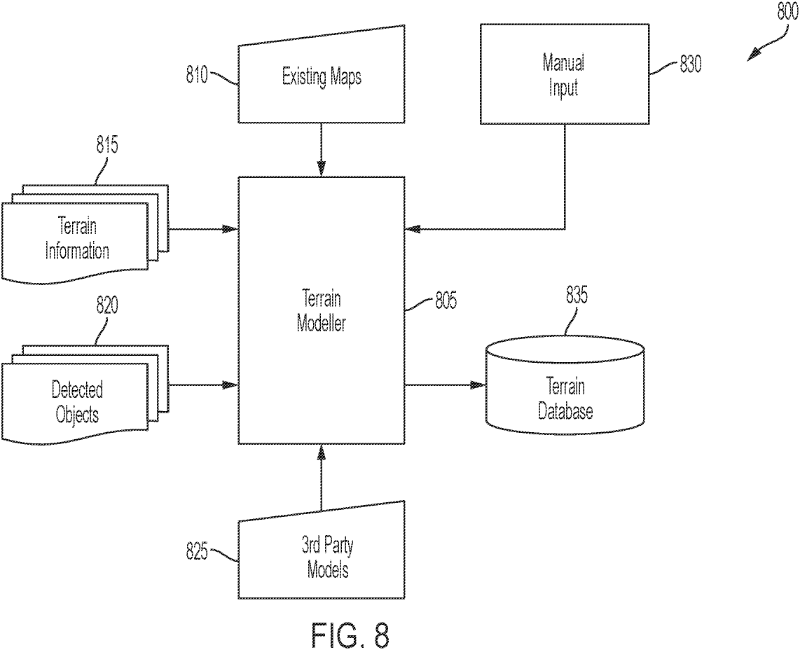

FIG. 8 illustrates elements of a system 800 for creating a model of terrain in an environment. System 800 may be implemented as part of system 100, shown in FIG. 1. A processor 805 may create a model of a terrain for a terrain database 835. Processor 805 may obtain terrain information 815 as discussed above with respect to FIG. 7, and detected objects 820. Detected objects 820 may, for these purposes, include inanimate and immobile objects. Map information 810 may further be used as information for the processor to create a terrain model, as well as digital geo-tagged information from 3^{rd} party map models 825. Manual input 830 may also be provided by an administrator to apply geo-tag or other terrain information or corrections to map data, terrain data, or any other data to create an accurate model in terrain database 835. The terrain database 835 may store both public and private environments to allow a user access to terrain models that are within the user’s home, for example, and also in the user’s neighborhood or other places.

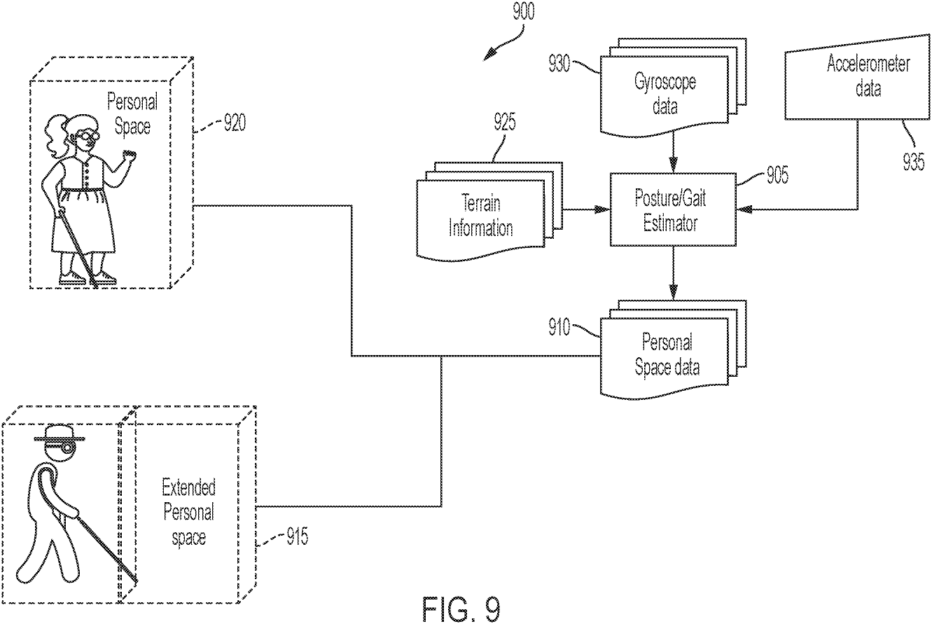

FIG. 9 illustrates elements of a system 900 for generating a posture/gait information. System 900 may be implemented as part of system 100, shown in FIG. 1. Processor 905 may be used to estimate a posture and gait for a particular person to produce personal space data 910. Personal space data 910 may incorporate extended personal space 915 which is defined as a region of interest when a user is in motion, including areas which the user may be traveling into within the immediate future or a short span of time based on the user’s gait and walking speed. Personal space data 910 further includes immediate personal space 920 which is defined as approximately all areas reachable by extending arms, legs, or cane 180 at a particular time. Extended personal space 915 may extend from personal space 920 to an area that a user will encounter within a short span of time based on the person’s walking speed.

Walking speed is affected by terrain and, thus, terrain information 925 may be provided to processor 905 as well as gyroscope data 930 and accelerometer data 935 from gyro/accelerometer 155 to estimate a user’s gait, posture, and walking speed. Terrain information 925 may also identify personal space boundaries for assessing whether or not a detected object is within a user’s path (e.g., inside or outside the user’s personal space or extended personal space boundaries).

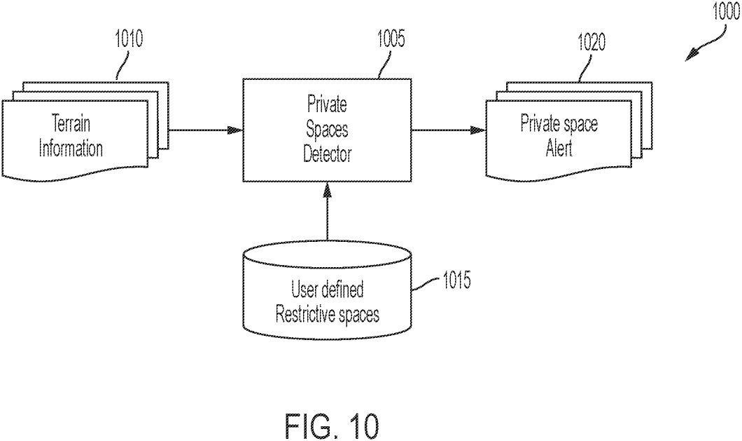

FIG. 10 illustrates elements of a system 1000 for estimating personal space around a user. System 1000 may be implemented as part of system 100, shown in FIG. 1. In some situations, a user may desire that private spaces not be either mapped or observed by a camera, such as a bedroom or a restroom. In such cases, a processor 1005 may use terrain information 1010 and user defined restricted private spaces 1015 to create an alert 1020 through personal electronic device 135, for example, that causes a camera 145 in personal electronic device to be turned-off while the user is within the private space to ensure the user’s privacy.

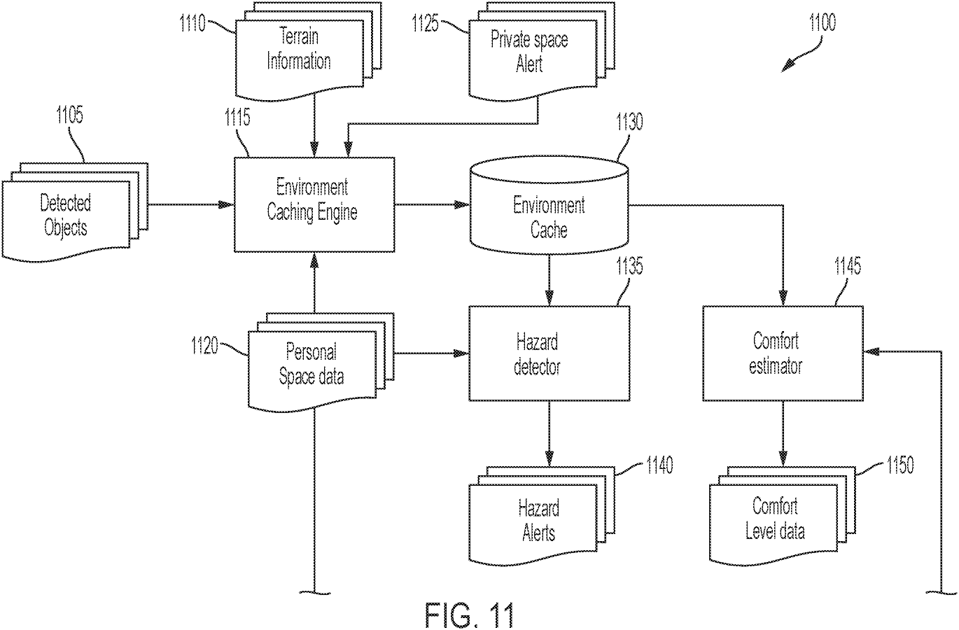

FIG. 11 illustrates a system 1100 for analyzing an environment around a user. System 1100 may be implemented as part of system 100, shown in FIG. 1. System 1100 serves to store and update terrain information 1110 and detected objects 1105. Objects that are detected 1105, terrain information 1110, and personal space data 1120 may be stored within environment caching engine 1115 which includes an associated memory database 1130. Environment caching engine 1115 may also store private space alert information 1125 which indicates that a person has entered a portion of the terrain, such as a bathroom or a bedroom, as discussed above, where a camera and optical sensor should be turned off.

Memory database 1130 may further provide information to hazard detector 1135 which may cause a hazard alert 1140 to be transmitted by personal electronic device 135. Hazards may include objects that cause obstructions, collision likelihoods, a presence of fragile objects, incoming traffic, and other similar hazards encountered by people inside and outside of their homes. Memory database 1130 may also provide data stored within memory database 1130 to comfort estimator 1145, which may also be informed by personal space data 1120, to produce comfort level data 1150. Comfort estimator 1145 may be implemented by a processor that determines comfort levels for sustaining a particular activity. For example, when walking the comfort level of a user may depend on a crowd density, unevenness of surfaces, and familiarity with a particular place. Comfort level 1150 may be generated continuously or with a high periodicity to properly assess the number and type of objects in the path of a user.

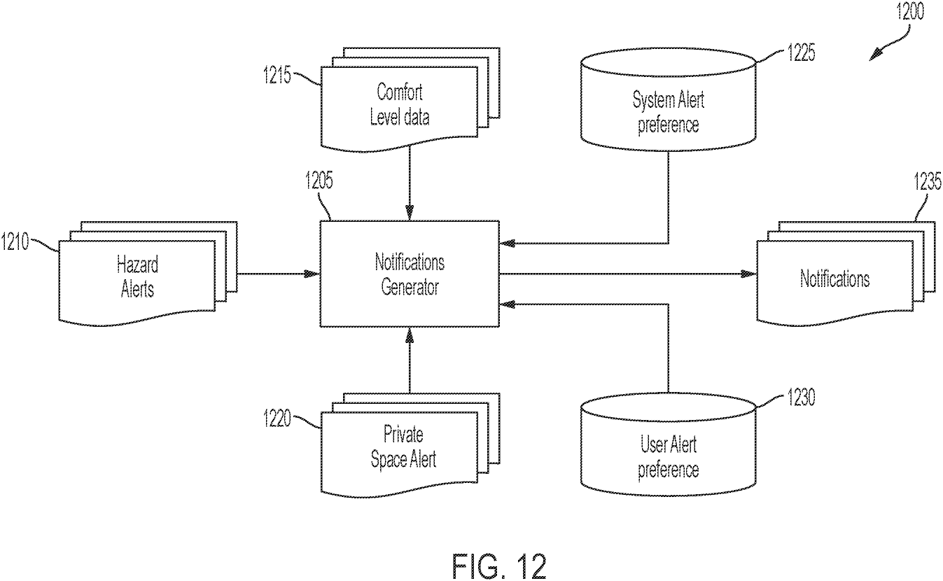

FIG. 12 illustrates a system 1200 for providing notifications about the environment to a user. System 1200 may be implemented as part of system 100, shown in FIG. 1. For example, notifications generator 1205 may be implemented by processor 110 in server computer 105. A hazard alert 1210 may be generated, as previously discussed with respect to system 500, shown in FIG. 5 which may be sent to notifications generator 1205. Notifications generator 1205 may also receive information about comfort level data 1215 and private space alerts 1220, as previously discussed. Notifications generator 1205 may further receive information from a system alert preference database 1225 and a user alert preference database 1230 to determine whether or not a notification should be generated. When a notification is to be generated, a notification 1235 may be generated through either vibration unit 175, microbraille printer 170, or by an audible alert from personal electronic device 135.

Due to the incorporation of LIDAR technology, much more precise three dimensional data may be measured over short to long range regardless of environment or lighting conditions. Thus, personal electronic device 135 may be used to read text, recognize faces, identify products, recognize barcodes, recognize money, identify objects, identify colors, identify environments, and assist with street navigation, public transportation, and access to parks and recreation.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system, comprising:
a server computer including a processor,
a device including an optical sensor,
a cane including a haptic controller,
wherein the device is causes the haptic controller in the cane to provide one or more notifications to a user.

2. The system of claim 1, further comprising:
an artificial intelligence core; and
an artificial intelligence data memory storage.

3. The system of claim 2, wherein images from the optical sensor are compared against data in the artificial intelligence data memory storage to identify objects detected by the optical sensor.

4. The system of claim 3, wherein the artificial intelligence core compares the images from the optical sensor against data in the artificial intelligence memory data storage to identify objects detected by the optical sensor.

5. The system of claim 1, wherein the cane connects wirelessly to the device.

6. The system of claim 1, wherein the haptic controller includes a braille printer.

7. The system of claim 1, wherein the haptic controller includes a vibration unit.

8. The system of claim 1, wherein the device provides an audible warning.

9. The system of claim 1, wherein the optical sensor is a camera.

10. The system of claim 1, wherein the optical sensor is a LIDAR optical sensor.

11. The system of claim 1, wherein the server includes an artificial intelligence core which receives images from the optical sensor.

12. The system of claim 1, wherein the artificial intelligence core incorporates a first custom neural network for identifying objects detected by a LIDAR optical sensor.

13. The system of claim 12, wherein the artificial intelligence core incorporates a second custom neural network for identifying objects detected by a camera optical sensor.

14. The system of claim 1, wherein the artificial intelligence core incorporates a second custom neural network for identifying objects detected by a camera optical sensor.

15. The system of claim 1, wherein the server processor identifies a location of the user based on data collected by the optical sensor.

16. The system of claim 15, wherein the server processor identifies a terrain associated with a location of the user based on data collected by the optical sensor.

17. The system of claim 1, wherein the server processor identifies a private space and, in response, turns off the optical sensor.

18. The system of claim 17, wherein the private space is a location identified by the user of the device.

19. The system of claim 1, wherein the server processor identifies a personal space and an extended personal space.

20. The system of claim 19, wherein the one or more notifications to a user includes an identification of one or more objects which are in or near the user’s extended personal space.
